(19) United States
(12) Patent Application Publication
(10) Pub. No.: US 2016/0128151 A1
(43) Pub. Date: May 5, 2016

(54) Low Current LED Lighting System

(71) Applicant: Urban Solar Corporation, Victoria (CA)

(72) Inventors: Garnet Scott Luick, Victoria (CA); Jeffrey David Peters, Victoria (CA); Yuval Uriel, Mission (CA)

(73) Assignee: Urban Solar Corporation, Victoria (CA)

(21) Appl. No.: 14/533,911

(22) Filed: Nov. 5, 2014

(51) Int. Cl. H05B 33/08; H02J 7/35; H02J 7/00

(52) U.S. Cl. CPC H05B 33/0845; H02J 7/007; H02J 7/35; H05B 33/089

(57) ABSTRACT

A solar powered lighting system comprises a photovoltaic array coupled to a rechargeable battery and an LED array having a variable brightness output. A memory device contains a lighting profile for each day of a calendar year at a predetermined geophysical location on the surface of the earth, and includes a calendar of events including times of activation and deactivation of one or more LED arrays and brightness levels associated with each array for each event. A real time clock times the reading of the events by a controller in a control module for controlling the intensity of the LED array such that the LED array is energized at preselected times as determined by the real time clock and at preselected intensities based upon the lighting profile and includes a control module that consumes on average no more than 2 mA of current.

### CROSS-REFERENCE TO RELATED APPLICATIONS

Not applicable.

### BACKGROUND OF THE INVENTION

Solar powered lighting systems are frequently used to illuminate areas in which there is difficulty connecting to a wired power grid, or where it is desired to use a renewable energy source. Some systems operate according to some preprogrammed schedule in which a timer is set to turn on and turn off lights at various times of the day or night. Others have sensors that sense ambient light conditions and issue commands to turn on or turn off lights accordingly. However, if the sensors are masked by a foreign object, illuminated by an artificial source, or if there are considerations other than ambient light, such systems are inadequate and either will fail to provide light when needed or waste energy, depleting battery reserves for times when lights are needed. One problem with timed systems is that due to changes in seasons, the timing and length of periods of daylight and darkness change. In addition, these changes can be rather extreme the further away from the equator that such a system is located. There are marked differences in the timing of periods of light and dark between for example, the 45^{th} parallel and the 55^{th} parallel, and there are extreme swings in day/night periods as seasons change at northern latitudes. Moreover, some geographical areas use daylight savings time, while others do not.

Other issues involve the degree of utilization of a lighting system during nighttime. For example if the lighting system is to be used in a transportation kiosk like a bus stop, it may be desirable to operate lights only until the busses stop running, or at least to dim the lighting intensity during periods of light use or non-use. Thus, a system programmed to operate according to a timer must be periodically reset in order to compensate for changes in the daylight/darkness cycle, the location of the system and other seasonal adjustments related to use.

In order to rely on solar power to operate a lighting system, it is necessary to collect solar energy during the day, store it, and use it at night. There are days during which there is little sunlight and so care must be taken to maximize the efficiency of all components requiring electrical power to operate. Solar power is used to charge batteries during the day, which in turn power the lights at night. It is thus necessary to maximize the amount of power storage and minimize power usage.

Light emitting diodes (LED's) are very efficient as illumination devices, and may be driven by pulses of current that are pulse width modulated (PWM). The duty cycle of the PWM pulse determines the luminous intensity of an array of LED's. Although the LED's are turning on and off to provide a net luminance, the on-off flicker is too fast for the human eye to see and the net effect is a perceived steady state glow.

While such LED arrays are very efficient, they require controllers to generate the PWM pulses and to determine the timing when the array is to be turned on. Typically, such controllers consume over 8 milliamps of current even in a quiescent mode (i.e. self current consumption). This constant current drain may deplete battery reserves prematurely and may cause system shut down during a time when illumination of an area is needed, particularly when utilizing smaller solar arrays and/or with limited battery storage capacity

### SUMMARY OF THE INVENTION

A solar powered lighting system comprises a photovoltaic array coupled to a rechargeable battery and an LED array having a variable brightness output. A memory device contains a lighting profile for each day of a calendar year at a predetermined geophysical location on the surface of the earth, and includes a calendar of events including times of activation and deactivation of one or more LED arrays and brightness levels associated with each array for each event. A real time clock times the reading of the events by a controller in a control module for controlling the intensity of the LED array such that the LED array is energized at preselected times as determined by the real time clock and at preselected intensities based upon the lighting profile.

The lighting profile is designed so that system energy requirements do not exceed the available stored energy.

The controller is designed to operate so as to minimize the quiescent current draw, to no more than 2 milliamps on average.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a block schematic diagram of an exemplary battery powered solar lighting system.

FIG. 2 is a flow chart diagram illustrating the operation of the solar lighting system of FIG. 1.

FIGS. 3A-3E are a detailed flow chart diagram that shows the operation of the control module of FIG. 1.

FIG. 4 is a flow chart diagram of an interrupt service routine that runs periodically.

### DESCRIPTION OF THE PREFERRED EMBODIMENTS

In one aspect of the invention, a lighting system is provided having a photovoltaic array coupled to a rechargeable battery and an LED array having a variable intensity brightness powered by the battery. A low power control module for determining the variable intensity brightness operates according to predetermined event calendar and lighting profile that is in turn, based upon an energy profile derived from projected available energy.

The system is designed for maximum energy efficiency and has a controller drawing on average no more than 2 milliamps of quiescent current. Firmware resident in the controller is designed to maximize the amount of time the controller stays in a low power mode.

In another aspect, the system utilizes a database containing a lighting profile comprising a calendar of events corresponding to times of daylight and darkness and projected available solar energy specific to a geophysical location, and a real time clock synchronized to local time for reading programmed events in the calendar.

In yet another aspect of the invention, the system includes user override features that permit the calendar timing and/or luminance levels to meet the needs of local conditions.

In another aspect of the invention, a control module includes a programmable controller that may be programmed according to a lighting profile to establish preference periods so that select hours may be given more preference than others in terms of luminance and/or hours of operation.

In yet another aspect of the invention, the controller may be tailored so that the lighting profile that controls the system's illumination is based in part upon the projected available solar energy.

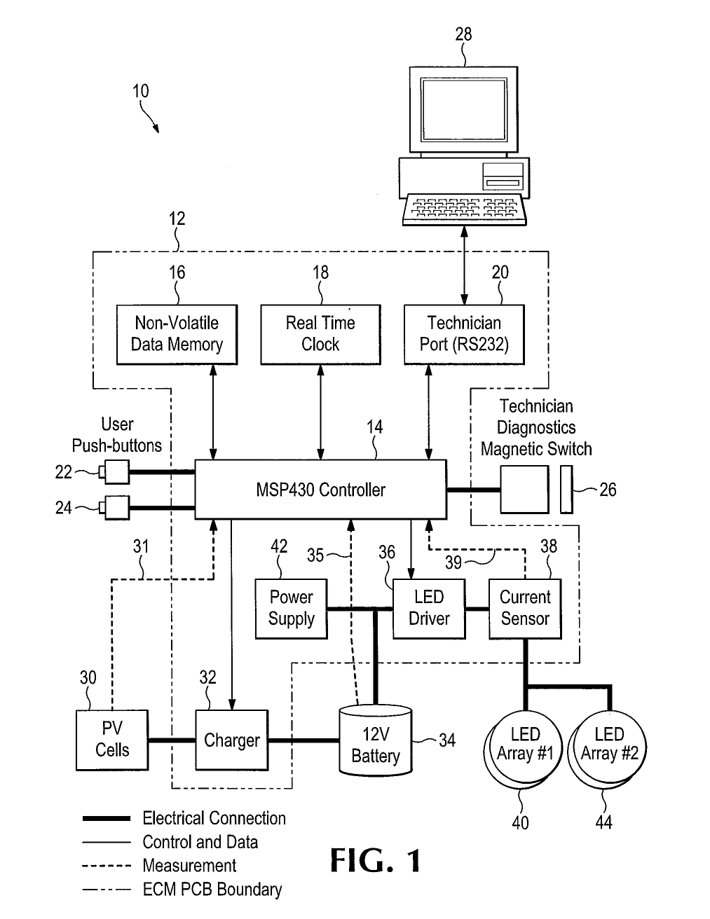

Referring to FIG. 1, a solar lighting system 10 includes a control module 12 that performs the control functions for the system. These include turning lights on and off, sensing certain battery conditions, user instructions, regulating battery recharging, and data storage. The control module 12 includes a controller 14, which is preferably an MSP430 microcontroller, available from Texas Instruments. Coupled to the controller 14 are a memory unit 16, a real time clock 18, and an RS232 port 20. Inputs to the controller 14 from outside the control module 12 include user pushbuttons 22 and 24, and a technician's diagnostic switch 26. A computer 28 for inputting data to the system may be connected to the RS232 port 20.

Solar energy is collected during periods of daylight by an array of photovoltaic (PV) cells 30. The output of the PV cell array 30 is coupled to a charger 32 in the control module 12. The charger 32 in turn charges a rechargeable battery 34, in this case a 12-volt battery; however, the exact voltage rating of the battery is unimportant.

The charger 32 is a maximum power tracking point (MPTP) type of charger designed to harvest maximum power from the solar panel. When power from the solar array is harvested at maximum voltage and down converted to battery voltage, current is increased thereby boosting the amount of charge the battery receives. This is desirable in a system that is “off grid” and must rely solely on collected solar energy, especially during the winter months when there is less sunlight.

The output of the battery 34 is coupled back to the control module 12 to an LED driver 36 and the module's power supply 42. The LED driver 36 is preferably a pulse width modulated (PWM) driver, although other types of drivers may be used as long as they are capable of variable output for controlling the degree of light intensity.

The LED driver 36 is connected through a current sensor 38 to a pair of LED arrays, LED arrays 40 and 44. The LED arrays 40 and 44 may operate independently of each other as will be explained infra.

The controller 14 monitors several parameters, including the voltage output of the solar array 30 by line 31, the output voltage of the battery 34 by line 35 and the output of the current sensor 38 by line 39. These parameters are used by the controller 14 in setting what is called the DIM level or brightness intensity of the LED arrays in conjunction with a pre-loaded calendar and lighting profile that is downloaded to the memory unit 16.

The system controller 14 uses data stored in the memory 16 that is derived from environmental factors and from meteorological data available from government agencies for a given installation site defined by latitude and longitude. The available data includes times of daylight and darkness for each day of a calendar year at a specific geophysical location. In addition, the government data includes the solar intensity for each date at the select location. Solar intensity varies with latitude and season because of the sun's angle relative to the earth. Government data also provides meteorological information based upon multi-year averages of cloud cover and precipitation. All of these factors may be used to generate a database from which an energy profile is derived which predicts the available amount of solar energy on a certain day at various times during the year. The energy profile, in turn, will be used to set limits on the timing and brightness level of the LED array for each calendar day of the year. The energy profile is generated from simulations based upon all available government data and is combined with the calendar data to determine a conservative lighting profile that may be continuously variable. The lighting profiles are loaded into the memory 16 and, based on specific predetermined calendar appointments, set the LED “on” times and DIM or intensity levels to optimize the performance of the system for the anticipated solar conditions, thus providing at least the minimum customer specified LED “on” time and brightness level while at the same time using the most energy efficient system to achieve those minimum specifications. The system sets a conservative lighting profile in advance of the solar changes so as to ensure that the ratio of energy used/available energy is always <1.

In addition, the system performance data (i.e., battery state of charge), will automatically adjust the LEDs to a lower power (or turn them off) in the case where the battery is not receiving sufficient charge to maintain the required energy balance.

The controller 14 thus functions as both a timed switch and brightness adjustment device. The main function is a loop that periodically (every ˜16 seconds) reads the data from the analog to digital converter of the main processor—this includes the battery voltage, the solar panel voltage, and the time from the real time clock (RTC); it then looks to see if a calendar appointment is triggered at that time. If an appointment occurs within that 16-second interval then it reads the DIM setting in the lighting profile and enables the LEDs. The DIM level is set by pulse width modulation (PWM). The LEDs are pulsed at a given frequency that corresponds to the set DIM level—the higher the duty cycle of the pulse, the brighter the LEDs will appear to be. The pulsing occurs at a high rate that the human eye cannot detect, so the LEDs appear to be steady on even though they are actually turning off and on at a very high rate.

The LVD (low voltage disable) function is in fact what protects the battery from going below a preset minimum level of charge (determined by the battery voltage reading). If the battery level is below that value, the LEDs do not come on and hence the load on the battery is disabled. Once the system recharges the battery above another preset value (battery voltage), which might take several hours or days of solar charging, then the LEDs are enabled again. Thus, the system automatically adjusts for real time conditions and modifies the lighting profile stored in memory accordingly.

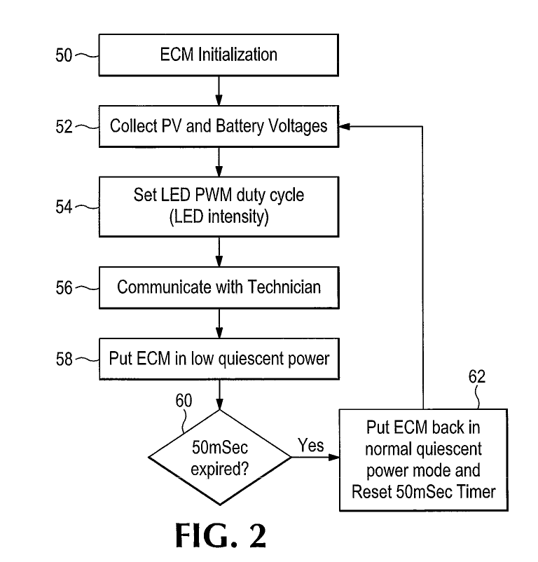

Referring to FIG. 2, a simplified flow chart diagram is shown which illustrates the operation of the control module 12. At block 50, the controller 14 (called the ECM or electronic control module) initializes. At block 52, it reads the voltage on the PV cell array 30 via line 31 and the battery voltages via line 35. At block 54, it sets the PWM duty cycle for the LED arrays 40 and 44. This is a multi-step process, which will be explained in more detail below. At block 56, it reads any new input from the RS232 port 20 and at block 58, it puts the ECM into low quiescent power or “sleep” mode. It stays in sleep mode at block 60 until 50 msec have expired and then at block 62 it resets a 50-msec timer and loops back to block 52.

Thus, once every 50 msec, the system performs this data collection and control loop and is otherwise quiescent. In other words, it performs the tasks in blocks 52-58 and then waits in a low power mode for 50 msec to expire. The average quiescent power consumption is determined by the ratio between the active portions of the loop in blocks 52-58 and the amount of time idling at block 60. This insures efficient operation of the ECM and an average low current draw of no more than 2 mA.

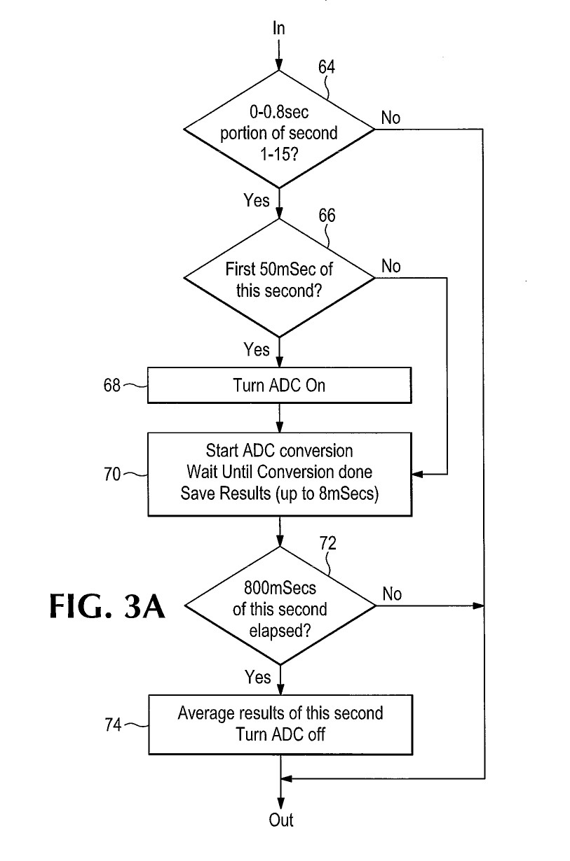

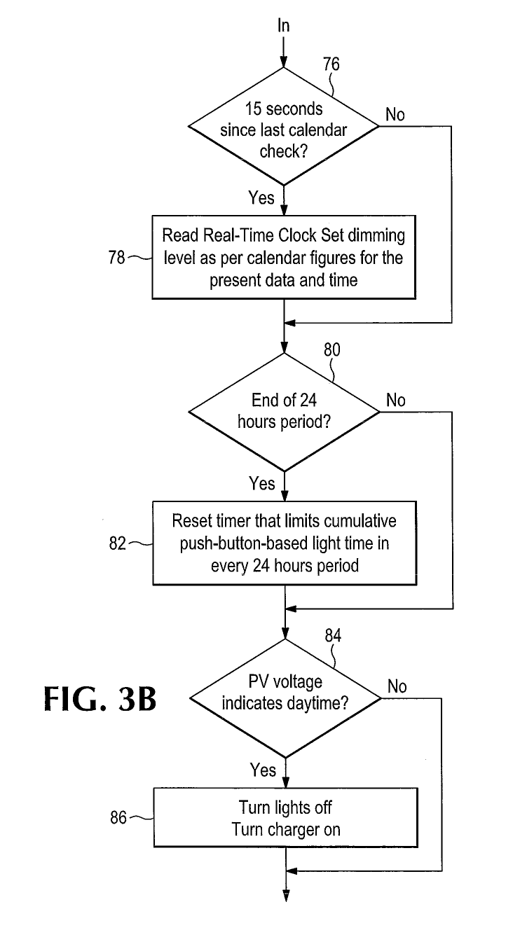

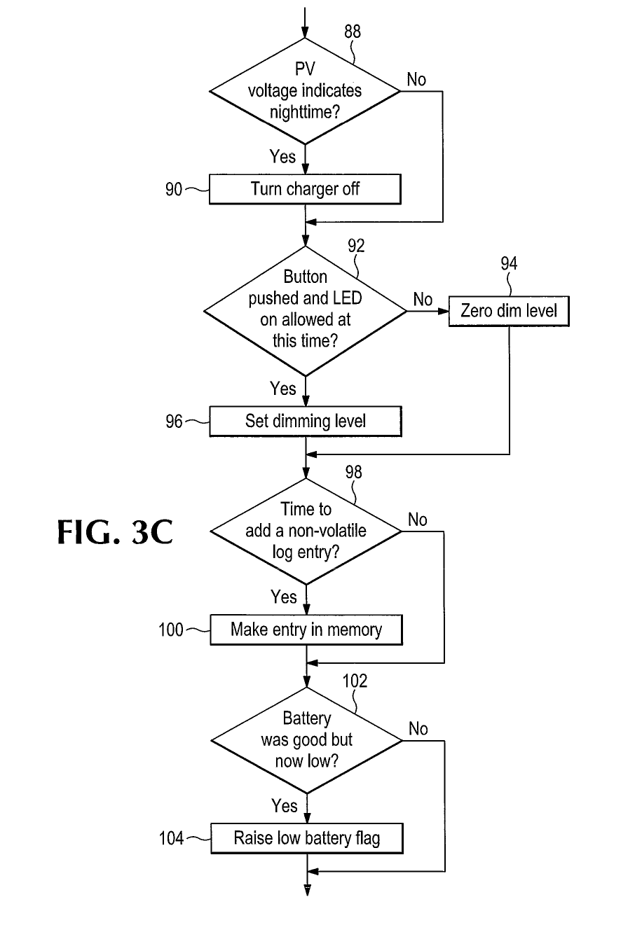

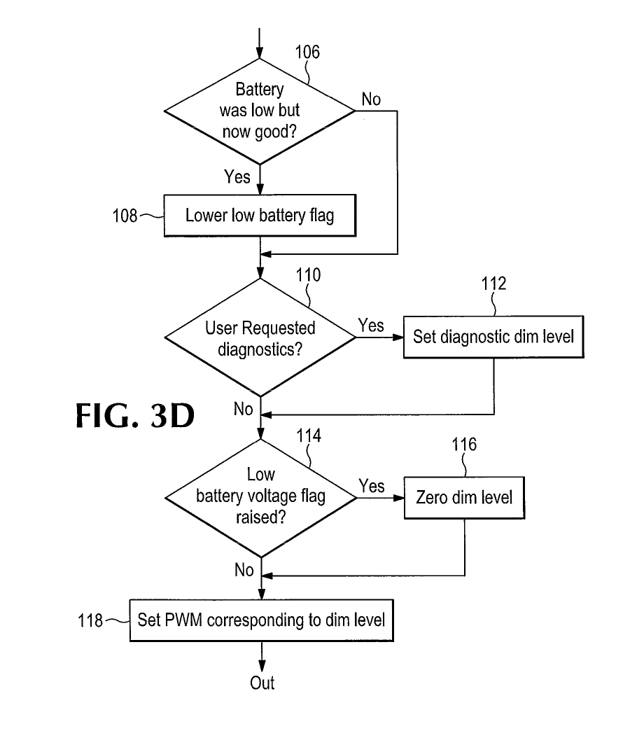

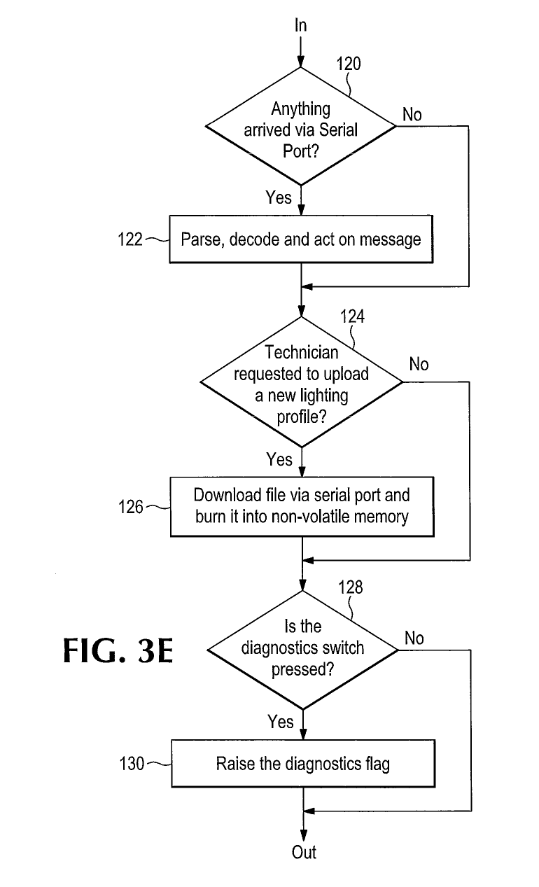

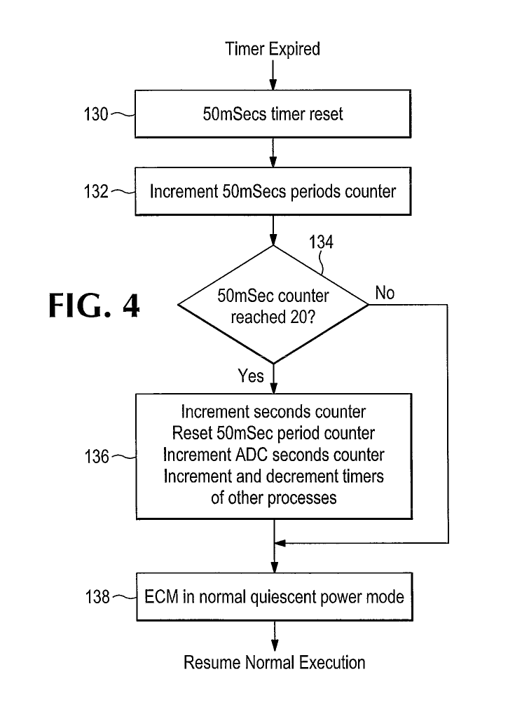

Referring to FIGS. 3A-3E: FIG. 3A illustrates block 52 of FIG. 2; FIGS. 3B-3D illustrate block 54 of FIG. 2; FIG. 3E illustrates block 56 of FIG. 2; and FIG. 3F illustrates block 58 of FIG. 2.

In FIG. 3A, a timer at block 64 determines if the system clock is within the first 800 msec of any one of the first 15 seconds of a 15-second time interval. If yes, then a timer at block 66 determines if within the current second the time is within the first 50 msec. If yes again, at block 68 the ADC (analog to digital converter resident in the controller 14 is turned on. At block 70, ADC conversion of the data on lines 31, 35 and 39 begins and continues for 8 msec. Results are saved in memory. If by this time 800 msec have elapsed (block 72), the results are averaged (block 74) and the ADC is turned off and the program loop proceeds to the subroutine of FIG. 3B.

At block 66, if the time is outside the first 50 msec of seconds 1-15 the program jumps to block 70 because the ADC is already on. At block 64 if the timer is not within an 800 msec portion of seconds 1-15, the ADC function is skipped and the program jumps to the subroutine of FIG. 3B. Thus, analog to digital conversion takes place only during the first 800 milliseconds of each second. At block 72 when analog to digital conversion takes place before 800 msec elapses, the data is stored waiting for the end of the 800 msec time interval.

The chart of FIG. 3B illustrates the setting of the light intensity of the LED arrays 40 and 44. This accomplished by setting the width of pulse-modulated pulses in the LED driver 36. At block 76, a timer determines if it has been 15 seconds since the last calendar check. In this context, the “calendar” refers to the lighting profile in the memory 16. This profile contains a schedule of events which are activation and deactivation times for the LED arrays synchronized to local real time. The calendar also contains LED intensity information for specific timing events. If 15 seconds have elapsed since the last reading of the memory 16 per the real time clock 18, calendar data is read (block 78). If this is the end of a 24-hour period at block 80, the 24 timer is reset (block 82). This limits the ability of a user to turn the LED's on via one of the pushbuttons 22 or 24. At block 84, the PV voltage is read to determine if it is day or night. If there is enough daylight to reach a set threshold, the LED's are turned off and the battery charger 32 is activated (block 86).

Referring to FIG. 3C if (block 88) it is nighttime the charger 32 is turned off (block 90). Next, the system checks (block 92) to see if a user pushbutton is on and if an LED array is allowed “on.” If both conditions are not satisfied (block 94), the DIM level is set to zero. If “yes” (block 96), the DIM level is set to a preprogrammed level stored in memory 16.

Next, the system (block 98) checks for any log entries made by a technician via the RS 232 port 20. These might be changes in the lighting profile based on expected user needs or changing weather conditions. If changes are necessary, they are added to the memory 16 (block 100).

In order to execute the lighting profile, there must be sufficient battery power, so at block 102 the battery voltage is read on line 35. If the battery is too low, a flag is raised (block 104). If the battery voltage is sufficient to execute the lighting profile, block 104 is skipped and the program proceeds to block 106 at which the battery strength is confirmed. At block 108, restrictions on battery use are removed and the system operates normally according to the lighting profile.

If the battery is still low and user diagnostics have been requested (block 110), a special diagnostic DIM level may be set (block 112) that takes into account available battery power. This may include lowering the light intensity or shutting the LED's off entirely a certain period of time.

If no user diagnostics are requested, the controller determines if the low battery voltage flag is raised (block 114). If “yes”, a zero DIM level is set (block 116). At block 118, the pulse width from the PWM driver is set which corresponds to the results of the decision tree of FIG. 3D.

The preloaded lighting profile may always be altered to meet user needs or changing conditions. The subroutine of FIG. 3E illustrates how this function is accomplished. After setting the PWM pulse width, the controller 14 checks to see if there is data at the serial port 20 (block 120). If yes, the data is parsed and decoded (block 122). If not, the system checks for a new lighting profile (block 124) and if “yes” the new profile is downloaded and stored in the memory 16 (block 128). The system then checks to see if the diagnostics switch 126 has been set and if “yes” a diagnostics flag is raised.

After executing the functions of the program of FIGS. 3B-3E, the system is in quiescent mode until the 50 msec timer runs down. Once the timer expires, the interrupt service routine of FIG. 3F runs. At block 130, the 50 msec timer is reset and the 50 msec period counter increments (block 132). Once the counter reaches the value of 20 (block 134) a second has elapsed and the system increments several counters (block 136). These include the seconds counter, the ADC counter and any other counter that requires reset once per second. After that, the interrupt subroutine exits and the controller 14 reverts to normal loop execution.

Another interrupt routine (not shown) is launched when a user pushbutton such as button 22 is pushed. This sets a timer that runs down after the pushbutton flag is detected at block 92. Other functions may be assigned to a second user pushbutton 24 as desired.

The complete firmware resident in the controller 14 functions in a 50-msec loop, and is executing for 800 msec of each second. After 800 msec (i.e., 16 loops), the data collected is averaged for that period and stored in a volatile memory. In each 50-msec loop, the controller 14 is in “active” state, that is, the controller is collecting and storing data and using the analog to digital converter for 8 msec. Then the controller is in “sleep” state for 42 msec.

Once each 15 seconds, an additional portion of the program is executed within one of the 50-msec loops. When the additional portion is executing, the processor is in active state for some additional portion of the 50-msec loop that is greater than 8 msec. and for a conservative calculation, one can assume the controller is active for the entire 50 msec.

Thus, the time spent in active mode is: for seconds 1-15, 8/50, or approximately 16% of the time, the controller is in active mode. In the sixteenth second, the controller is assumed to be 100% active. Therefore, the total time spent by the controller in an active state is about 17% of the time.

It is known from the specifications that in the active mode a controller of this type draws no more than 7 mA and in sleep mode draws no more than about 500 micro amps. Thus on average, the controller draws less than 2 mA of current. The low current draw makes the system as a whole very energy efficient, thus maximizing the amount of stored energy available to power the LED arrays.

The system is fully self-contained because the lighting profile is structured to equal the most conservative estimate of available energy to power the system on a daily basis. The method of insuring this result includes the steps of gathering data available from government sources, such as NASA, that includes the total amount of insolation that occurs on each given day of the year at each specific geophysical location where the system is to be used. This takes into account on a daily basis, times of light and darkness and the angle of the sun's rays relative to the earth's surface at such locations. From this number it can be calculated how much energy will be collected on any given day by the photovoltaic array and stored in the battery. Certain assumptions or estimates can be made to take into account meteorological effects such as cloud cover as well as a ‘wear out’ factor to account for end of life system performance—i.e. degradation of solar panels due to aging and/or grime build up. From this data collection, an energy profile can be calculated. The energy profile may then be used to create a lighting profile that comprises a calendar of timed events that are programmed into the database memory 16 as commands to activate and deactivate the LED arrays 44 and 40 and where to set the DIM levels whenever the LED arrays are activated. The lighting profile is set so that its energy requirements for a given previous time period (day, week or month) are less than the energy profile calculated for the previous time period (day, week or month). In this way, the system does not run out of power and replenishes itself for the next time period.

With such a system, numerous other features are available which may compensate for desires of particular users or changed conditions. The lighting profile may be altered to cause the system to use less energy overall or to divide the energy usage between busy and non-busy periods. For example, with two LED arrays, one may be set to be full on from 8 p.m. to midnight and then turned off while the second array may be set at 50% brightness from midnight to 4 a.m. Many other combinations of brightness levels and activation events may be included in the lighting profile as desired by the user.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A solar powered lighting system comprising
A photovoltaic array coupled to a rechargeable battery
An LED array powered by said battery and having a variable intensity brightness,
A low power control module for determining said variable intensity brightness according to a predetermined lighting profile, said control module having a controller drawing on average no more than 2 milliamps of current.

2. The solar powered lighting system of claim 1 further comprising a real time clock coupled to said low power controller and synchronized to local time at a predetermined geographical location for timing the lighting of said LED array according to said lighting profile.

3. The solar powered lighting system of claim 2 further including a user override control for manually activating or deactivating said LED array.

4. The solar powered lighting system of claim 1 further including a pulse width modulated (PWM) driver powered by said battery, wherein said variable intensity brightness is determined by a pulse width of said PWM driver.

5. A solar powered lighting system comprising:
A photovoltaic array coupled to a rechargeable battery, the battery having energy stored during energy collection periods according to a projected energy profile;
An LED array having a variable brightness output;
A memory device containing a lighting profile for each day of a calendar year at a predetermined geophysical location on the surface of the earth, said lighting profile comprising a calendar of events including times of activation and deactivation of one or more LED arrays and brightness levels associated with each array for each said event;
A real time clock;
A control module for reading the lighting profile and controlling the intensity of the LED array whereby said LED array is energized at preselected times as determined by said real time clock and at preselected intensities based upon said lighting profile wherein the lighting profile for each period of use does not exceed the energy profile of a previous energy collection period.

6. The solar powered lighting system of claim 5 wherein said control module includes a low power controller drawing on average no more than 2 mA of current.

7. The powered lighting system of claim 5 wherein the control module includes a pulse width modulation LED driver wherein the intensity of the LED array is a function of a pulse width of an output of the LED driver.

8. The powered lighting system of claim 5 further including manual controls for selectively controlling the activation of the LED array.

9. The powered lighting system of claim 5 wherein said battery produces a voltage for operating said LED driver, said pulse width being determined in part by a real time value of said voltage.

10. The powered lighting system of claim 9 wherein said memory device further includes user input data for overriding said real time data to alter the intensity of the LED array at preselected times and/or at preselected intensities.

11. The powered lighting system of claim 5 further including a charger for said battery, said charger coupled to said photovoltaic array wherein said controller senses a voltage output from said photovoltaic array to determine a real time bright or dark ambient light condition and selectively activate or deactivate said charger.

12. The powered lighting system of claim 5 wherein said lighting profile calls for a total energy usage during a preset period which is less than an energy profile indicating the expected amount of solar energy to be collected during a previous preset period.

13. The powered lighting system of claim 11 wherein the energy profile comprises a data collection based upon the insolation received at said geophysical location over a predetermined time period.
